(19) United States
(12) Patent Application Publication
(10) Pub. No.: US 2008/0203838 A1
(43) Pub. Date: Aug. 28, 2008

(54) Dynamic Bearing Device

(76) Inventors: Isao Komori, Kuwana-shi (JP); Ryouichi Nakajima, Kuwana-shi (JP); Masaharu Hori, Kuwana-shi (JP); Kazuto Shimizu, Kuwana-shi (JP); Tatsuo Nakajima, Iwata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/629,458

(22) PCT Filed: Sep. 14, 2005
(86) PCT No.: PCT/JP05/16970

§ 371 Date: Dec. 14, 2007

(30) Foreign Application Priority Data
Oct. 7, 2004 (JP) 2004-295258
Jan. 18, 2005 (JP) 2005-010748
Apr. 19, 2005 (JP) 2005-121255

(51) Int. Cl. H02K 7/08; F16C 17/10

(52) U.S. Cl. 310/90; 384/228

(57) ABSTRACT

A dynamic pressure generation portion is formed on the outer circumferential surface 2a1 of a shaft portion 2a. This allows for forming a bearing member 7 into which a housing and a sleeve-shaped member that were conventionally separately configured due to the machinability of the dynamic pressure generation portion are integrated. The opening at one end of the bearing member 7 is sealed with a cover member 8 integrated with the bearing member 7 or with a separate cover member 8 secured to the bearing member 7.

### BACKGROUND OF THE INVENTION

1. Field of the Invention

The present invention relates to a dynamic bearing device. This dynamic bearing device is preferably used for the spindle motor of information apparatus, for example, magnetic disk units such as an HDD, optical disc units such as a CD-ROM, CD-R/RW, and DVD-ROM/RAM, and magneto-optical disc units such as an MD and MO; for the polygon scanner motor of a laser beam printer (LBP); for the color wheel of a projector; and for the compact motor of electric devices, for example, an axial fan.

2. Description of the Related Art

By way of example, the aforementioned dynamic bearing device includes one which utilizes a dynamic pressure action of fluid produced in a radial bearing gap and a thrust bearing gap to support a shaft member in the radial and axial directions in a non-contact manner. There is known a dynamic bearing device of this type in which dynamic pressure generating grooves serving as dynamic pressure generation means are formed on the inner circumferential surface of the bearing sleeve, on the end surface of the bearing sleeve confronting the end surfaces of the flange portion of the shaft member, and on the bottom surface of the housing (e.g., see Japanese Patent Laid-Open Publication No. 2000-291648).

The aforementioned dynamic bearing device is made up of a number of parts such as the bearing sleeve and the housing for accommodating the bearing sleeve in addition to the shaft member. In recent years, as the information apparatus is reduced in price, there is also an increasingly stringent demand for reduction in costs of the dynamic bearing device of this type. To meet this demand, it is an urgent need to further reduce costs such as by decreasing the number of parts and reviewing the manufacturing steps.

### BRIEF SUMMARY OF THE INVENTION

In view of these circumstances, it is therefore an object of the present invention to provide a dynamic bearing device at further reduced costs.

To achieves the aforementioned object, a dynamic bearing device according to the present invention is characterized by comprising: a bearing member; a shaft member inserted therein on its inner circumference; and a radial bearing portion for supporting a rotating member in a radial direction in a non-contact manner using a dynamic pressure action of fluid produced in a radial bearing gap between the bearing member and the shaft member, wherein a dynamic pressure generation portion for generating a dynamic pressure of fluid on an outer circumferential surface of the shaft member, and an opening at one end of the bearing member is sealed with a cover member integrated with the bearing member or a separate cover member secured to the bearing member.

Unlike the aforementioned problem-solving means having the dynamic pressure generation portion formed on the outer circumferential surface of the shaft member, the dynamic pressure generating groove may be formed as the dynamic pressure generation portion, for example, on the inner circumferential surface of a sleeve-shaped member. In this case, a known exemplary method of forming the dynamic pressure generating groove is available in which the member in question is made of a sintered metal, and a core rod having a groove shape is inserted into the member in question on its inner circumference to be then pressurized in a die, thereby allowing the groove shape to be transferred to the inner circumferential surface of the sleeve-shaped member in order to form the dynamic pressure generating groove (e.g., Japanese Patent Laid-Open Publication No. Hei 11-182550). However, in this method, it is necessary to accommodate the sleeve-shaped member as well as to separately prepare a cylindrical bottomed member (housing) for sealing an opening at one end thereof and positively secure both with accuracy such as by means of adhesion or press-fit. Accordingly, this results in an increase in the number of parts and complication in man-hours for assembly, thus causing an impediment to reduction in costs of the dynamic bearing device.

In contrast, according to the present invention, the dynamic pressure generation portion is formed on the outer circumferential surface of the shaft member. Accordingly, unlike the dynamic pressure generation portion formed on the inner circumferential surface of the sleeve-shaped member, the sleeve-shaped member and the housing need not to be formed of separate members because of the machinability of the dynamic pressure generation portion. On the contrary, it is possible to employ one member into which both are integrated (bearing member). In terms of the outer shape, this difference lies in that with the conventional one, the cover member for sealing the opening at one end of the sleeve-shaped member was included integrally or separately in the housing which was independently separated from the sleeve-shaped member, whereas with the one according to the present invention, the cover member in question is included integrally or separately in the bearing member. As such, the conventional two members (the sleeve-shaped member and the housing) are integrated into one member (the bearing member) to thereby decrease the number of parts and eliminate the step of assembling the two members into one piece. This makes it possible to reduce the dynamic bearing device in costs.

The methods for forming the dynamic pressure generation portion on the outer circumferential surface of the shaft member include, for example, such as forging, rolling, or printing. As an exemplary method of these ones for forming the dynamic pressure generation portion by printing, a method is available in which a small amount of ink is applied to the surface of a material to cure the aggregate of the small amount of ink and thereby form the dynamic pressure generation portion.

Any method may be employed to supply a small amount of ink. For example, a so-called ink-jet method may be employed in which ink is bombarded or dispensed to the surface of the material through a nozzle having a reduced diameter. In addition to the aforementioned method, there are also available other methods such as a nozzle-less type ink-jet method for ejecting ink droplets not through a nozzle but from the level of the ink; a method for guiding ink by electrophoresis; a method for continuously discharging ink not in the form of droplets but continuously through a micro-pipette; and a method for bombarding ink to a landing surface at the same time as the ink is discharged by shortening the distance to the landing surface.

For example, to form a shape corresponding to the dynamic pressure generation portion by printing on the outer circumferential surface of the shaft member, available is a known method of using an anti-corrosive ink of resin compositions for printing. In this method, a printing die is moved while being in contact with the outer circumferential surface of the shaft portion as the shaft portion is rotated, thereby printing the portions other than the dynamic pressure generating groove on the outer circumference of the shaft portion (e.g., see Japanese Patent Publication No. Sho 62-49351). However, this method requires a printing die and a printing screen for retaining the printing die due to the nature of the manufacturing method. Additionally, a large amount of ink is also required for printing, and after printing, non-printed portions must be corroded and the ink removed by etching or the like, thus making it difficult to reduce costs.

In contrast to this, provided is the above-illustrated method for forming the dynamic pressure generation portion by supplying a small amount of ink. In this method, a geometric pattern of the dynamic pressure generation portion can be pre-programmed to thereby allow any geometric pattern to be printed, and the amount of discharged ink (a resin composition) can be precisely controlled to thereby allow each portion of the geometric pattern to be formed in any thickness. Accordingly, the cured ink itself can form the dynamic pressure generation portion with high accuracy. This allows the shaft member having the dynamic pressure generation portion formed thereon to be incorporated as it is into the dynamic bearing device for use as a bearing surface without being subjected to a corroding step such as etching. This can greatly simplifies the steps of forming the dynamic pressure generation portion. Furthermore, since ink is supplied to the shaft portion (material) in a non-contact manner, the printing die and the printing screen for retaining the printing die are not required. A mechanism for moving the printing die as the material is rotated is also not required, thus making it possible to simplify the patterning apparatus. Furthermore, since such an amount of ink that is used only for forming the dynamic pressure generation portion is enough, the amount of ink used can be reduced.

To form the dynamic pressure generation portion by printing, the conventional method employs an etching step additionally after a printing step. In this case, the ink for forming, for example, a dynamic pressure generating groove serving as the dynamic pressure generation portion is completely removed after etching, thus allowing no completed ink component to be left. However, on the aforementioned shaft portion according to the present invention, the ink is not removed but left for use. In this case, theoretically, since the resin composition (the remaining ink) slidingly contacts the bearing member with the material of the shaft member being in non-contact with the bearing member, the property required of the material or resistance to wear is reduced in importance. Accordingly, this can provide an increase in flexibility of selecting a material for the shaft member. This also eliminates the need of thermal processing to provide improved resistance to wear. Thus, the shaft member can be formed of a thermally non-processed metal material, thereby reducing the costs for materials. From like viewpoints, the material of the bearing member may be selected with a high degree of flexibility because considerations can be sufficiently made to resistance to wear not for metal but for resin.

In general, the dynamic bearing device is provided with a seal space for preventing leakage of a fluid (e.g., a lubricating oil) filled in the interior of the bearing unit. During operation of the bearing, there may occur an increase in pressure inside the bearing unit, especially in the thrust bearing gap of the thrust bearing portion, resulting in a pressure difference of the lubricating oil between the seal spaces. Such a pressure difference may likely cause degradation in performance of the dynamic bearing device.

To solve the aforementioned problem, the bearing member can be provided with a circulating flow passage that communicates between a thrust bearing gap and a seal space for sealing an opening at the other end of the bearing member, where the thrust bearing gap supports the shaft member in the thrust direction in a non-contact manner using the dynamic pressure action of fluid. Even when a fluid pressure difference occurs between the thrust bearing gap and the seal space, such a configuration can balance the pressures of both the spaces by allowing the fluid to flow between both the spaces through the circulating flow passage, thereby allowing for maintaining a stable bearing performance.

The aforementioned bearing member is made of a resin material or a metal material, and can be formed by any one of injection molding, press forming, and machining.

A motor including the dynamic bearing device configured as described above, a rotor magnet, and a stator coil can be preferably used as a spindle motor or the like for the aforementioned information apparatus, for example, a magnetic disk drive apparatus such as a hard disk drive (HDD).

To achieve the aforementioned object, the present application provides a dynamic bearing device characterized by comprising: a rotating member having a shaft portion; a bearing member having an inner circumferential surface confronting an outer circumferential surface of the shaft portion; a radial bearing portion for supporting the rotating member in a radial direction in a non-contact manner using a dynamic pressure action of fluid produced in a radial bearing gap between the shaft portion and the bearing member; and a thrust bearing portion for supporting the rotating member in a thrust direction in a non-contact manner using a dynamic pressure action of fluid produced in a thrust bearing gap, wherein a dynamic pressure generation portion for generating a dynamic pressure of fluid is formed on the outer circumferential surface of the shaft member, an opening at one end of the bearing member is sealed with a cover member integrated with or separated from the bearing member, and a first thrust bearing surface having a dynamic pressure generation portion is molded on one end surface of the bearing member confronting the thrust bearing gap.

This configuration allows a configuration of one member (the bearing member) into which the sleeve-shaped member and the housing are integrated. In addition to this, since the first thrust bearing surface having the dynamic pressure generation portion is formed by molding on one end surface of the shaft member confronting the thrust bearing gap, the dynamic pressure generation portion can be formed on the bearing member with efficiency. This makes it possible to further reduce costs.

The dynamic pressure generation portion provided on the outer circumferential surface of the shaft portion can be formed by curing an aggregate of a small amount of ink.

In addition to the aforementioned configuration, it is possible to mold a second thrust bearing surface, having a dynamic pressure generation portion, on the cover member or the other end surface of the bearing member. As such, the second thrust bearing surface is formed in addition to the first thrust bearing surface. This allows the dynamic pressure action of fluid produced between the two thrust bearing gaps confronting both the bearing surfaces, respectively, to support the shaft portion in both the thrust directions in a non-contact manner. The second thrust bearing surface is formed by molding thus with efficiency and high accuracy, thereby making it possible to further reduce costs.

The aforementioned cover member and bearing member are made of a resin material or a metal material, and can be formed by any one of injection molding, press forming, and machining.

In the aforementioned configuration, for example, the rotating member can be made up of a shaft member, and a rotor portion extending towards the outer diameter side of the shaft member and having a portion for receiving a rotor magnet. In this case, it is desirable to dispose a magnetic material at least at a portion of the rotor portion confronting the rotor magnet. During operation of the motor, such a configuration can prevent leakage of magnetic flux established between the stator coil and the rotor magnet via the rotor portion and thereby loss in magnetic force, thereby providing improved rotational performance to the motor.

A motor including the dynamic bearing device configured as described above, a rotor magnet, and a stator coil can be preferably used as a spindle motor or the like for the aforementioned information apparatus, for example, a magnetic disk drive apparatus such as a hard disk drive (HDD).

As described above, the present invention makes it possible to provide a dynamic bearing device at further reduced costs.

### BRIEF DESCRIPTION OF THE DRAWINGS

FIG. 1 is a cross-sectional view showing a spindle motor for use with an information apparatus into which incorporated is a dynamic bearing device according to an embodiment of the present invention.

FIG. 2 is a cross-sectional view showing a dynamic bearing device according to an embodiment.

FIG. 3 is a schematic view showing an ink-jet printing device.

FIG. 4 is a view showing the lower end surface of a bearing member.

FIG. 5 is a view showing the upper end surface of a cover member.

FIG. 6 is a cross-sectional view showing a dynamic bearing device according to a second embodiment.

FIG. 7 is a cross-sectional view showing a dynamic bearing device according to a third embodiment.

FIG. 8 is a cross-sectional view showing a dynamic bearing device according to a fourth embodiment.

FIG. 9 is a cross-sectional view showing a dynamic bearing device according to a fifth embodiment.

FIG. 10 is a cross-sectional view showing a dynamic bearing device according to a sixth embodiment.

FIG. 11 is a cross-sectional view showing a dynamic bearing device according to a seventh embodiment.

### DETAILED DESCRIPTION OF THE INVENTION

Now, embodiments of the present invention will be explained below with reference to the accompanying drawings.

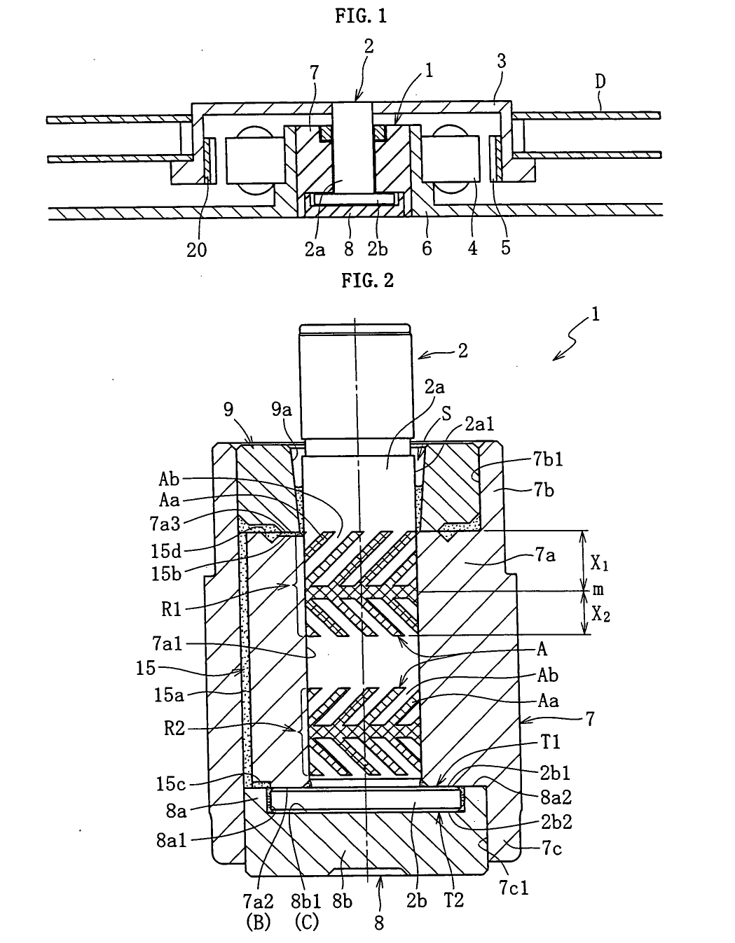

FIG. 1 conceptually shows an exemplary configuration of a spindle motor for use with an information apparatus into which incorporated is a dynamic bearing device 1 according to an embodiment of the present invention. This spindle motor for an information apparatus, which is used with a disk drive unit such as an HDD, includes the dynamic bearing device 1, a disk hub 3 serving as a rotor portion secured to a shaft member 2 of the dynamic bearing device 1, a stator coil 4 and a rotor magnet 5 which face each other, for example, via a radial gap, and a bracket 6. The stator coil 4 is secured onto the outer circumference of the bracket 6. The rotor magnet 5 is secured onto the inner circumference of the disk hub 3. The disk hub 3 retains one or more disks “D,” such as magnetic disks, on its outer circumference. A bearing member 7 of the dynamic bearing device 1 is secured onto the inner circumference of the bracket 6. Driving currents applied to the stator coil 4 induce electromagnetic forces between the stator coil 4 and the rotor magnet 5 to thereby rotate the rotor magnet 5, and rotation of the disk hub 3 and the shaft member 2 ensues therefrom.

FIG. 2 shows an example of the aforementioned dynamic bearing device 1. The dynamic bearing device 1 includes the shaft member 2 having a shaft portion 2a at the center of rotation, the bearing member 7 having a sleeve-shaped portion and allowing the shaft portion 2a to be inserted therein on the inner circumference thereof, a cover member 8 for sealing the opening at one end of the bearing member 7, and a seal member 9 disposed at the other end of the bearing member 7. For convenience in description, it is to be understood that the cover member 8 side is referred to as the “lower” direction and the seal member 9 side as the “upper” direction.

The shaft member 2 is formed of a metal material, for example, such as stainless steel, including the shaft portion 2a and a flange portion 2b provided integrally therewith or separately therefrom at one end thereof. Two radial bearing surfaces “A” serving as a dynamic pressure generation portion are spaced apart from each other axially on an outer circumferential surface 2a1 of the shaft portion 2a. For example, a radial bearing surface “A” includes dynamic pressure generating grooves “Ab” arranged in a herringbone shape and hill-shaped partitions “Aa” for defining the dynamic pressure generating grooves “Ab.” With the upper radial bearing surface “A,” the dynamic pressure generating grooves “Ab” are formed asymmetrically in the axial direction with respect to the axial center “m,” such that an axial size X1 of the upper region with respect to the axial center “m” is greater than an axial size X2 of the lower region. For this reason, when the shaft member 2 rotates, the force provided by the dynamic pressure generating grooves “Ab” for pulling (pumping) the lubricating oil is relatively greater on the upper radial bearing surface than on the lower radial bearing surface “A” which is symmetric. Any number of radial bearing surfaces “A” may be formed, for example, one or three or more can be formed. In this embodiment, the end surfaces 2b1 and 2b2 of the flange portion 2b are formed to have a flat surface without dynamic pressure generating grooves.

The radial bearing surface “A” can be formed such as by means of forging, rolling, or printing. Among forming methods by printing, this embodiment specifically employs an ink-jet printing method in which multiple minute droplets of a free-flowing resin composition (ink) are dispensed through a nozzle onto the outer circumferential surface 2a1 of the shaft portion 2a, on which the ink is to land, and then cured, so that an aggregate of the small amount of ink forms the partition “Aa” for the dynamic pressure generating grooves “Ab.”

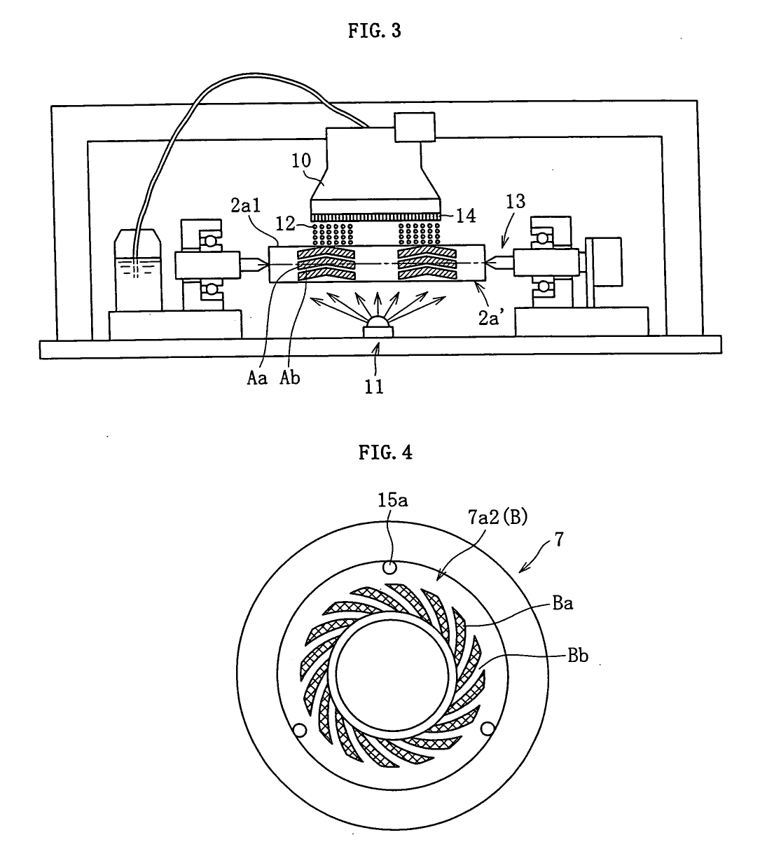

FIG. 3 schematically shows an ink-jet printing device for forming the dynamic pressure generation portion on the outer circumferential surface 2a1 of the shaft portion 2a. As shown, this printing device is mainly composed of one or more nozzle heads 10 positioned to confront the outer circumferential surface 2a1 of a material 2a′ of the shaft portion 2a to be rotatably driven, and a curing portion 11 which is circumferentially dislocated with respect to the nozzle head 10, preferably to confront the nozzle head 10 with the material 2a′ interposed therebetween as illustrated. The nozzle head 10 has a plurality of nozzles 14 axially disposed to dispense ink 12 in the form of minute droplets. The ink 12 is a resin composition which includes as a base resin, for example, a photo polymer, preferably an ultraviolet-ray curable polymer. The ink 12 to be employed may have an organic solvent added thereto at an appropriate proportion, as required. For example, the curing portion 11 to be employed as a source of light for emitting light to cure the resin composition is an ultraviolet lamp.

With the aforementioned configuration, while the material 2a′ is being rotated, the nozzle head 10 is slid back and forth in the axial direction to dispense the ink 12 through the nozzles 14, thereby allowing the minute droplets of the ink 12 to be bombarded to the predetermined positions on the outer circumferential surface 2a1 of the material 2a′. An aggregate of these multiple minute droplets allows a dynamic pressure generating groove pattern to be formed as a dynamic pressure generation portion on the outer circumferential surface 2a1 of the material 2a′, for example, the pattern having the dynamic pressure generating grooves “Ab” arranged in a herringbone shape and the partitions “Aa.” The printing of the dynamic pressure generating groove pattern is gradually proceeded along the circumferential direction while the material 2a′ is being rotated. When the printed portion reaches the region opposite to the curing portion 11, the ink 12 is illuminated with the ultraviolet light to be sequentially cured due to polymerization. While the ink is being alternately supplied through each nozzle or stopped as appropriate, the material 2a′ is turned once or several tens of times to form the dynamic pressure generating groove pattern on the entire circumference of the material 2a′. At this time, since the nozzle head 10 and the curing portion 11 are positioned to confront each other with the material 2a′ interposed therebetween, the ultraviolet light emitted from the curing portion 11 is blocked by the material 2a′, thereby preventing the ink 12 dispensed through the nozzles 14 from being cured due to polymerization. Accordingly, this configuration prevents the nozzles 14 from being clogged with the ink 12 cured, thus allowing for effectively forming the dynamic pressure generating groove pattern.

In the ink-jet printing method, the amount of dispensed ink minute droplets can be controlled, thereby allowing for managing the printed ink thickness with accuracy at each portion of the printed pattern. Accordingly, the ink 12 cured allows for ensuring a required depth of the dynamic pressure generating groove. Thus, for example, the dynamic pressure generating groove pattern formed as the dynamic pressure generation portion can be used as it is as the radial bearing surface “A” without being subjected to etching or a step of removing cured ink. In the conventionally employed printing method, the dynamic pressure generating groove was formed by printing on the outer circumferential surface 2a1 of the shaft portion 2a through steps of masking, etching (or sand-blasting in some cases), and removing the masking. However, employing the dynamic pressure generating groove pattern, printed as described above, as it is as the bearing surface makes it possible to eliminate a significant number of steps when compared with the conventional manufacturing procedure and thus further reduce costs. In this case, theoretically, since the resin composition of the shaft portion 2a (partition “Aa”) slidingly contacts the bearing member 7 with the material 2a′ of the shaft portion 2a being in non-contact with the bearing member 7, the property required of the material or resistance to wear is reduced in importance. Accordingly, this can provide an increase in flexibility of selecting the material of the shaft portion 2a. This also eliminates the need of thermal processing to provide improved resistance to wear. Thus, the shaft portion 2a can be formed of a thermally non-processed metal material, thereby reducing the costs for such materials. Of course, if costs are not so problematic, the dynamic pressure generating groove pattern may be etched after having been printed, and then the printed portion can be removed to form the dynamic pressure generating groove.

The bearing member 7 is formed generally in the shape of a cylinder. The bearing member 7 as shown as an example includes a sleeve portion 7a, a seal receive portion 7b disposed above it, and a sealing portion 7c disposed below it. An inner circumferential surface 7a1 of the sleeve portion 7a is less in diameter than an inner circumferential surface 7b1 of the seal receive portion 7b and an inner circumferential surface 7c1 of the sealing portion 7c, and confronts the two radial bearing surfaces “A” of the shaft member 2. The cover member 8, discussed later, is fixedly fitted into the sealing portion 7c on the inner circumferential surface 7c1. The inner circumferential surface 7a1 of the sleeve portion 7a is formed as a smooth cylindrical surface with no dynamic pressure generating grooves. As shown in FIG. 4, formed as a dynamic pressure generation portion on a lower end surface 7a2 of the sleeve portion 7a is a first thrust bearing surface “B” which includes a plurality of dynamic pressure generating grooves “Bb” arranged, for example, in a spiral fashion and partitions Ba for defining each of the dynamic pressure generating grooves “Bb.”

The seal member 9 is formed of a metal material or a resin material in an annular shape. In this embodiment, the seal member 9 is formed separately from the bearing member 7, and secured to the inner circumferential surface 7b1 of the seal receive portion 7b of the bearing member 7 such as by means of press-fitting or adhesion. An inner circumferential surface 9a of the seal member 9 is tapered so as to be increased in diameter in the upward direction. Between the inner circumferential surface 9a and the outer circumferential surface 2a1 of the shaft portion 2a confronting the inner circumferential surface 9a, an annular seal space “S” is formed. The seal space “S” gradually increases in radial size in the upper direction. A lubricating fluid, for example, a lubricating oil is injected into the inner space of the dynamic bearing device 1 sealed with the seal member 9, so that the dynamic bearing device 1 is filled with the lubricating oil. In this condition, the level of the lubricating oil is maintained within the range of the seal space “S.”

The bearing member 7 is provided with a flow passage 15 for communicating between the thrust bearing gap and the seal space “S” to circulate the lubricating oil. In a specific configuration of the flow passage 15, one or more lubricating oil flow passages 15a which penetrate the sleeve portion 7a in the axial direction are formed in a shoulder portion of the sleeve portion 7a (on the outer diameter side of the sleeve portion 7a). There is formed an annular flow passage 15d on an upper end surface 7a3 of the sleeve portion 7a. Thus, a first radial flow passage 15b is formed which passes from the annular flow passage 15d to the inner circumferential surface 7a1 of the sleeve portion 7a. On the outer diameter side of the lower end surface 7a2 of the sleeve portion 7a, there is formed a second radial flow passage 15c which passes from the flow passages 15a to the lower end surface 7a2 of the sleeve portion 7a. The provision of the flow passage 15 allows the fluid to flow between both the spaces through the circulating flow passage even in the presence of a difference in fluid pressure between the thrust bearing gap and the seal space. This allows for balancing the pressure between both the spaces, thereby maintaining the stability of the bearing performance.

The bearing member 7 is made of a resin material or a metal material, and is formed in one piece by any one of injection molding, press forming, and machining. In any of these forming methods, it is possible to readily form the bearing member 7 at low costs with high accuracy since the inner circumferential surface of the bearing member 7 is a smooth cylindrical surface without a dynamic pressure generating groove or the like. In forming the bearing member 7 by the aforementioned forming methods, particularly by injection molding or press forming, a shape may be formed at a portion, where the lower end surface 7a2 of the sleeve portion 7a is to be formed, corresponding to the shape of the dynamic pressure generation portion of the first thrust bearing surface “B.” This allows the first thrust bearing surface “B” to be formed simultaneously upon forming the bearing member 7, thereby ensuring a stable forming accuracy. For example, the first thrust bearing surface “B” may also be formed in a herringbone shape other than in a spiral fashion.

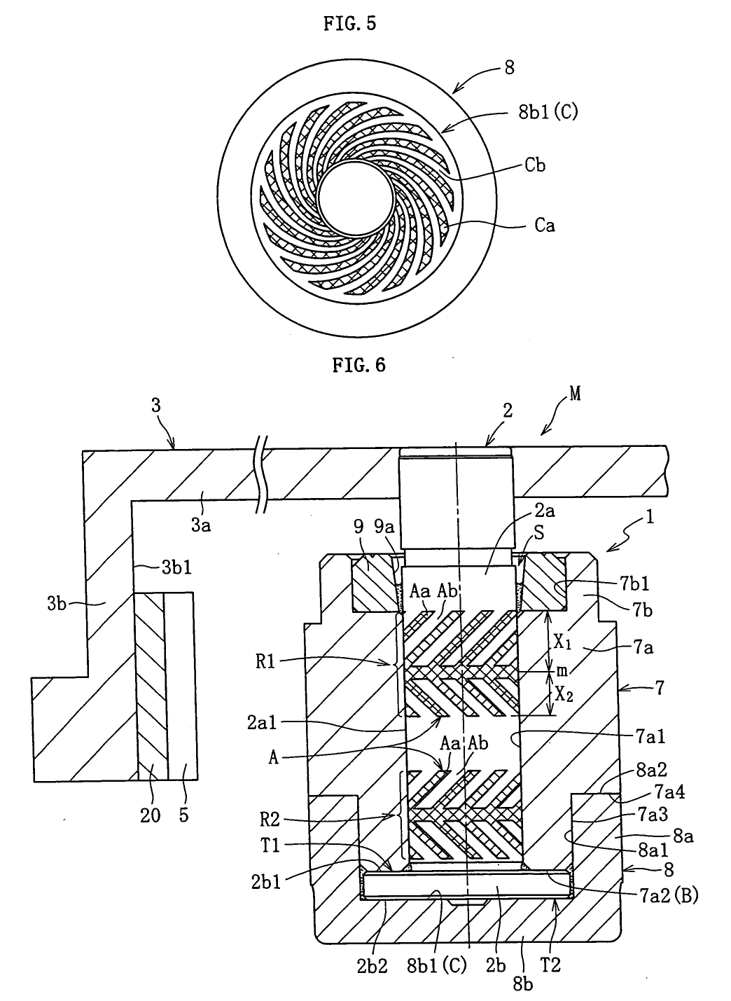

The cover member 8 is formed generally in the shape of a bottomed cylinder separately from the bearing member 7. The cover member 8 includes a cylindrical side portion 8a and a bottom portion 8b for sealing the lower end opening of the side portion 8a. The side portion 8a and the bottom portion 8b are integrally formed in the illustrated example. As shown in FIG. 5, on an upper end surface 8b1 of the bottom portion 8b, there is formed a second thrust bearing surface “C” as a dynamic pressure generation portion which includes, for example, a plurality of dynamic pressure generating grooves “Cb” arranged in a spiral fashion and partitions “Ca” for defining each of the dynamic pressure generating grooves “Cb.”

Like the bearing member 7 described above, the cover member 8 may also be made of a resin material or a metal material and formed in one piece by any one of injection molding, press forming, and machining. In forming the cover member 8 by the aforementioned forming methods, particularly by injection molding or press forming, a shape may be formed at a portion in a mold, where the upper end surface 8b1 of the bottom portion 8b is to be formed, corresponding to the shape of the dynamic pressure generation portion of the second thrust bearing surface “C.” This allows the second thrust bearing surface “C” to be formed simultaneously upon forming the shape of the cover member 8, thereby achieving a further reduction in costs. Of course, the second thrust bearing surface “C” may also be formed in a herringbone shape other than in a spiral fashion.

The cover member 8 is secured to the bearing member 7 by allowing an inner circumferential surface 8a1 of the side portion 8a to be fitted into the sealing portion 7c of the bearing member 7 on the inner circumferential surface 7c1 by means of press-fitting, adhesion, welding or the like as appropriate. At this time, the flange portion 2b of the shaft member 2 is accommodated in a space between the lower end surface 7a2 of the sleeve portion 7a of the bearing member 7 and the upper end surface 8b1 of the bottom portion 8b of the cover member 8. An upper end surface 8a2 of the side portion 8a of the cover member 8 is in contact with the lower end surface 7a2 of the sleeve portion 7a of the bearing member 7, thereby allowing for controlling the thrust bearing gap, discussed later, within a specified width.

The materials of the bearing member 7 and the cover member 8 can be selected as appropriate corresponding to the bearing property required. At this time, the cover member 8 and the bearing member 7 may be formed of any materials of either different types or the same type.

In the dynamic bearing device 1 configured as described above, when the shaft member 2 is rotated, the radial bearing surfaces “A” spaced apart from each other on the outer circumferential surface 2a1 of the shaft portion 2a each confront the inner circumferential surface 7a1 of the sleeve portion 7a of the bearing member 7 via the radial bearing gap. As the shaft member 2 rotates, the lubricating oil filled in each radial bearing gap produces a dynamic pressure action, and the resulting pressure allows the shaft member 2 to be rotatably supported in a non-contact manner in the radial direction. As such, there are formed a first radial bearing portion R1 and a second radial bearing portion R2 which rotatably support the shaft member 2 in a non-contact manner in the radial direction.

Furthermore, the first thrust bearing surface “B” formed on the lower end surface 7a2 of the sleeve portion 7a of the bearing member 7 confronts an upper end surface 2b1 of the flange portion 2b of the shaft member 2 via the first thrust bearing gap. The second thrust bearing surface “C” formed on the upper end surface 8b1 of the bottom portion 8b of the cover member 8 confronts a lower end surface 2b2 of the flange portion 2b via the second thrust bearing gap. As the shaft member 2 rotates, the lubricating oil filled in both the thrust bearing gaps produces a dynamic pressure action, and the resulting pressure allows the shaft member 2 to be rotatably supported in a non-contact manner in both the thrust directions. As such, there are formed a first thrust bearing portion T1 and a second thrust bearing portion T2 which rotatably support the shaft member 2 in a non-contact manner in both the thrust directions.

On the other hand, the aforementioned ink-jet method can be used to form the first thrust bearing surface “B” on the upper end surface 2b1 of the flange portion 2b and the second thrust bearing surface “C” on the lower end surface 2b2 of the flange portion 2b.

The dynamic bearing device 1 according to the present invention has the dynamic pressure generation portion formed on the outer circumferential surface 2a1 of the shaft member 2 as described above. From the viewpoints of the machinability of the dynamic pressure generation portion, this eliminates the need of separately configuring the sleeve-shaped member confronting the radial bearing gap and the housing for receiving the member in question, thus making it possible to use a member (the bearing member 7) into which both are integrated. Accordingly, it is possible to reduce the number of parts and man-hours required for assembly, thereby achieving low costs. Furthermore, the bearing member 7 and the cover member 8 can be formed by practical means of machining or press forming of a metal material or injection molding of a resin or the like, thus allowing manufacture costs to be further reduced. It is also possible to form the bearing member 7 and the cover member 8 by means of MIM (a type of injection molding) or low-melting-point metal injection molding or the like.

To form the dynamic pressure generation portion on the outer circumferential surface 2a1 of the shaft member 2, it is possible to employ, for example, appropriate means such as forging, rolling, or printing. Suppose that among these methods, the dynamic pressure generation portion is formed by printing. In this case, a method in which a small amount of ink is supplied onto the surface of a material of the shaft member 2 to cure the collection of the small amount of ink, or the aforementioned ink-jet method may be employed. By this method, the dynamic pressure generation portion intended to be formed on the shaft member 2 is formed in a projected shape on the surface of the material, thereby preventing the shaft portion 2a from slidingly contacting the sleeve portion 7a. Accordingly, no consideration needs to be given to the resistance to wear or the like of the metal material that forms the shaft portion 2a, thus allowing for selecting more inexpensive metal materials. Furthermore, in forming the dynamic pressure generation portion by the printing method, the etching step or the like, which was inevitable after printing in the conventional printing method, can be eliminated. In addition to this, an excessive amount of ink, consumable parts such as a printing die or the like will be dispensed with. It is thus possible to reduce manufacturing costs through the elimination of steps and the reduction of consumable parts.

In the foregoing, the embodiment of the present invention has been described; however, the present invention is not limited to the embodiment but may also be preferably applicable to the exemplary configurations of the dynamic bearing devices to be discussed below. In the following descriptions, the members and elements that are basically the same in functionality as those of the embodiment shown in FIG. 2 are denoted with like reference symbols and will not be described repeatedly.

FIG. 6 shows a dynamic bearing device according to a second embodiment. In the dynamic bearing device 1 according to this embodiment, the bearing member 7 has a different lower end shape and accordingly the cover member 8 is secured to a different position. More specifically, the cover member 8 is secured to the outer circumferential surface 7a3 on the lower end opening side of the bearing member 7, in which the upper end surface 8a2 of the cover member 8 is in contact with a shoulder surface 7a4 formed on the outer circumference of the sleeve portion 7a. As in the first embodiment shown in FIG. 2, the bearing member 7 and the cover member 8 are formed by practical means of machining or press forming of a metal material or injection molding of a resin or the like. In addition to this, both the members are provided by molding with the first thrust bearing surface “B” and the second thrust bearing surface “C,” respectively. Accordingly, the thrust bearing surface needs not to be formed separately, thereby making it possible to further reduce manufacturing costs. Although not shown in the drawings, it is desirable to form in the bearing member 7 a flow passage, for circulating a lubricating oil, which communicates between the thrust bearing gap and the seal space “S” in order to maintain the stability of dynamic pressure.

As shown in the drawing, in the dynamic bearing device 1 according to this embodiment, the shaft member 2 constitutes a rotating member “M” in conjunction with the disk hub 3 serving as a rotor portion that is attached to the upper end portion of the shaft member 2. The disk hub 3 includes a generally disk-shaped plate portion 3a and a cylinder portion 3b that is integrated on the outer circumference of the plate portion 3a. The disk hub 3 is secured to the upper end portion of the shaft member 2, for example, such as by means of swaging, welding (such as spot welding), adhesion, electro-deposition, blazing, C-clips, or screws.

For example, the disk hub 3 is formed by injection molding a resin. With the disk hub 3 being formed of a resin material in this manner, a magnetic flux established between the stator coil 4 and the rotor magnet 5 may leak via the disk hub 3, possibly causing a loss of magnetic force. However, as shown in FIG. 6, such a problem can be eliminated by disposing a magnetic shield member 20 of a ferromagnetic metal material between an inner circumferential surface 3b1 of the cylinder portion 3b and the rotor magnet 5. For example, the magnetic shield member 20 can be integrated with the disk hub 3 by insert molding. If the disk hub 3 itself is made of a ferromagnetic material, the magnetic shield member 20 is dispensed with.

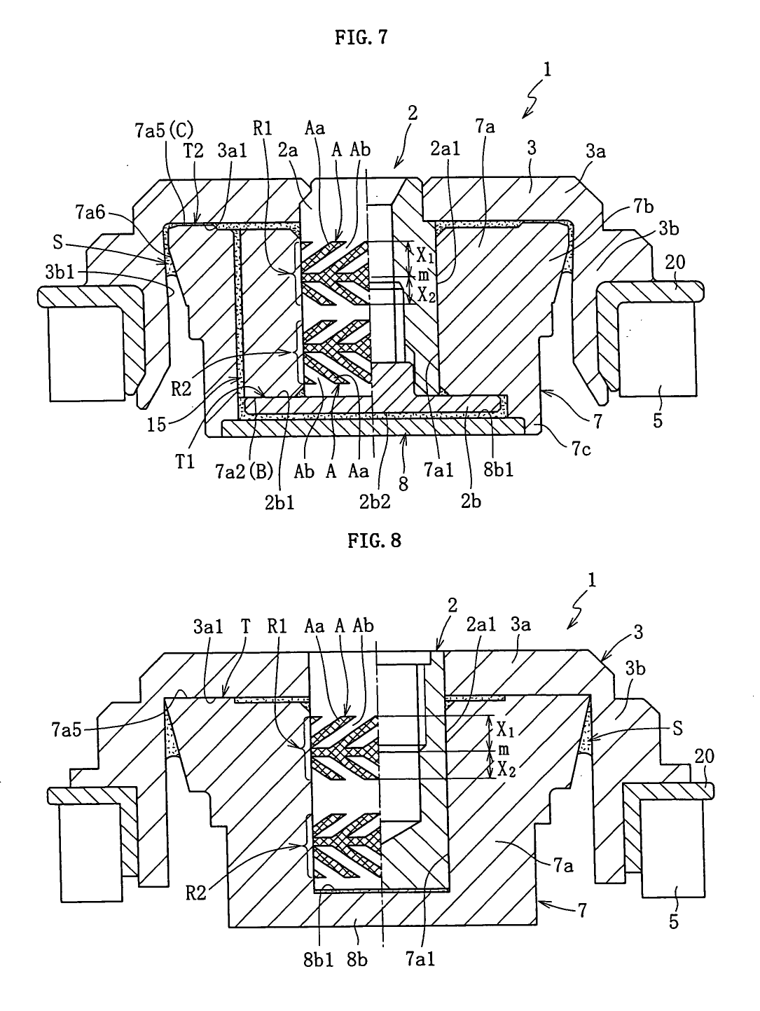

FIG. 7 shows a dynamic bearing device according to a third embodiment. The dynamic bearing device 1 according to this embodiment is greatly different from those of the embodiments shown in FIGS. 2 and 6 in that the second thrust bearing portion T2 is formed between an upper end surface 7a5 on the outer diameter side of the bearing member 7 and a lower end surface 3a1 of the plate portion 3a of the disk hub 3 in facing confrontation therewith. Another difference lies in that the seal space “S” is defined between an upper-end outer circumferential surface 7a6 of the bearing member 7 and the inner circumferential surface 3b1 of the cylinder portion 3b of the disk hub 3.

FIG. 8 shows a dynamic bearing device according to a fourth embodiment. The dynamic bearing device 1 according to this embodiment is greatly different from those of the aforementioned embodiments in that the flange portion 2b of the shaft member 2 is eliminated, and the bearing member 7 and the cover member 8 are formed in one piece. In this case, only a thrust bearing portion T is formed between the upper end surface 7 as on the outer diameter side of the bearing member 7 and a lower end surface 3a1 of the plate portion 3a of the disk hub 3 in facing confrontation therewith. Although not shown in the drawing, it is also possible to provide the flow passage 15 for circulating the lubricating oil, as required.

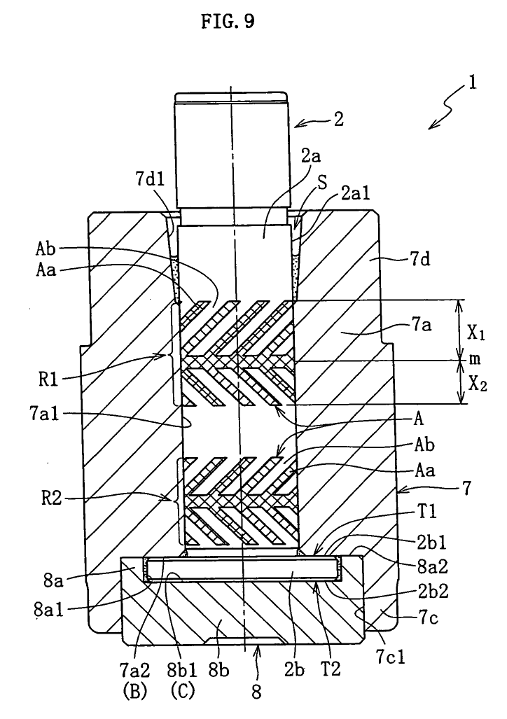

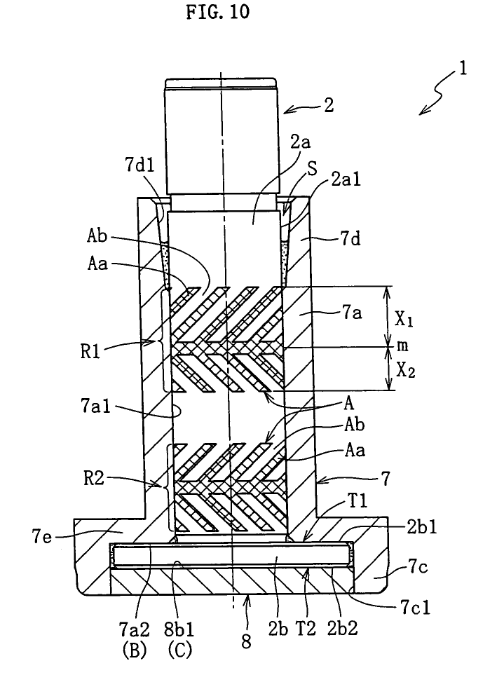

FIG. 9 shows a dynamic bearing device according to a fifth embodiment. The dynamic bearing device 1 according to this embodiment is greatly different from those of the aforementioned embodiments in that the seal member 9 is integrated with the bearing member 7. At this time, the seal receive portion 7b and the seal member 9 at the upper portion of the bearing member 7 according to the first embodiment shown in FIG. 2 are integrated into a seal portion 7d in this illustrated example, with the seal space “S” being defined between an inner circumferential surface 7d1 of the seal portion 7d and the outer circumferential surface 2a1 of the shaft member 2. Although not shown in the drawing, in this illustrated example, it is also possible to form the flow passage 15 for circulating the lubricating oil as shown in FIG. 2. In this implementation, it is possible to reduce the number of parts and man-hours required for assembly, thereby allowing the dynamic bearing device to be manufactured at further reduced costs.

FIG. 10 shows a dynamic bearing device according to a sixth embodiment. The dynamic bearing device 1 according to this embodiment shows a particularly preferable mode that the bearing member 7 is formed by injection molding a resin. The bearing member 7 includes the seal portion 7d, the sleeve portion 7a, a jaw portion 7e extending from one end of the sleeve portion 7a toward the outer diameter side, and the sealing portion 7c extending from the jaw portion 7e in the axial direction. The cover member 8 is secured by appropriate means onto the inner circumferential surface 7c1 of the sealing portion 7c. At this time, it is preferable in each of the aforementioned portions that the main part of each portion has the same thickness excluding such a portion that has a shape inevitable to its function (e.g., the tapered surface that is formed on the inner circumferential surface 7d1 of the seal portion 7d). This is because of the following reason. That is, for example, in the mode shown in FIG. 2, there is a big difference in thickness between the sleeve portion 7a and the sealing portion 7c. In this case, it is difficult to prevent warping or sinking from being caused by thermal contraction or the like after molding due to the property of the materials. The phenomena in question can likely have adverse effects on the assembly accuracy or the rotational accuracy of the dynamic bearing device. This mode is preferably applicable because the material cost can be reduced even when the bearing member 7 is formed of metal by press forming or MIM.

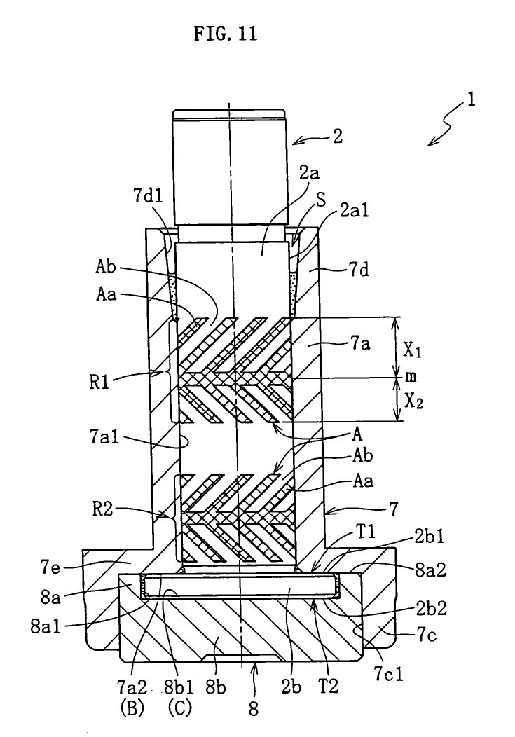

FIG. 11 shows a dynamic bearing device according to a seventh embodiment. The dynamic bearing device 1 according to this embodiment can provide the same effects as does that of the aforementioned sixth embodiment. In addition to this, as in the embodiments shown in FIGS. 2, 6, and 9, the dynamic bearing device 1 according to this embodiment is configured such that the width of the thrust bearing gap can be easily controlled. At this time, the flange portion 2b of the shaft member 2 is accommodated in a space between the lower end surface 7a2 of the sleeve portion 7a of the bearing member 7 (the lower end surface of the jaw portion 7e) and the upper end surface 8b1 of the bottom portion 8b of the cover member 8. The upper end surface 8a2 of the side portion 8a of the cover member 8 is in contact with the lower end surface 7a2 of the sleeve portion 7a of the bearing member 7, thereby allowing for controlling the thrust bearing gap within a prescribed width.

In each of the embodiments described above, descriptions were made to the cases where the configuration according to the present invention is used for the dynamic bearing device adapted to support the shaft member 2 in the thrust direction in a non-contact manner. However, other than these cases, this configuration can also be used for a dynamic bearing device adapted to support the shaft member 2 in the thrust direction in contact therewith. Furthermore, the shaft member 2 was to be formed of a metal material such as a stainless steel; however, other materials can also be selected as appropriate depending on the use thereof. For example, such a configuration can also be used in which the shaft member 2 has a composite structure of a metal material and a resin material, where the shaft portion 2a thereof is formed of a metal material, for example, such as stainless steel whereas the flange portion 2b is formed of a resin material integrally.

Still furthermore, in the aforementioned embodiments, illustrated was the bearing that employs the dynamic pressure generation portion, for example, including the herringbone or spiral dynamic pressure generating grooves, as the dynamic bearing constituting the radial bearing portions R1 and R2 and the thrust bearing portions T, T1, and T2. However, the configuration of the dynamic pressure generation portion is not limited thereto. As the radial bearing portions R1 and R2, it is also possible to employ a so-called multi-lobe bearing (which includes any of the tapered bearing and the tapered flat bearing) in which at a plurality of circumferential positions, the radial bearing gap is shrunk in the shape of a wedge in one or both circumferential directions. It is also possible to employ a so-called step bearing in which the dynamic pressure generating groove extending in the axial direction is formed at a plurality of circumferential positions. On the other hand, as the thrust bearing portions T, T1, and T2, it is also possible to employ a configuration in which at a plurality of circumferential positions, the thrust bearing gap is shrunk in the shape of a wedge in one or both circumferential directions.

What is claimed is:

1. A dynamic bearing device comprising: a bearing member; a shaft member inserted therein on its inner circumference; and a radial bearing portion for supporting the shaft member in a radial direction in a non-contact manner using a dynamic pressure action of fluid produced in a radial bearing gap between the bearing member and the shaft member, wherein
a dynamic pressure generation portion for generating a dynamic pressure of fluid on an outer circumferential surface of the shaft member, and
an opening at one end of the bearing member is sealed with a cover member integrated with the bearing member or a separate cover member secured to the bearing member.

2. A dynamic bearing device according to claim 1 wherein the dynamic pressure generation portion is formed by curing an aggregate of a small amount of ink.

3. A dynamic bearing device according to claim 2 wherein the shaft member is formed of a thermally non-processed metal material.

4. A dynamic bearing device according to claim 1 being further provided with a thrust bearing gap for supporting the shaft member in a thrust direction in a non-contact manner using a dynamic pressure action of fluid and a seal space for sealing an opening at the other end of the bearing member, and wherein the bearing member is provided with a circulating flow passage that communicates between the thrust bearing gap and the seal space.

5. A dynamic bearing device according to claim 1 wherein the bearing member is made of a resin or a metal, and is formed by any one of injection molding, press forming, and machining.

6. A motor comprising the dynamic bearing device according to claim 1, a rotor magnet, and a stator coil.

7. A dynamic bearing device comprising: a rotating member having a shaft portion; a bearing member having an inner circumferential surface confronting an outer circumferential surface of the shaft portion; a radial bearing portion for supporting the rotating member in a radial direction in a non-contact manner using a dynamic pressure action of fluid produced in a radial bearing gap between the shaft portion and the bearing member; and a thrust bearing portion for supporting the rotating member in a thrust direction in a non-contact manner using a dynamic pressure action of fluid produced in a thrust bearing gap, wherein
a dynamic pressure generation portion for generating a dynamic pressure of fluid is formed on the outer circumferential surface of the shaft member,
an opening at one end of the bearing member is sealed with a cover member integrated with or separated from the bearing member, and
a first thrust bearing surface having a dynamic pressure generation portion is molded on one end surface of the bearing member confronting the thrust bearing gap.

8. A dynamic bearing device according to claim 7 wherein the dynamic pressure generation portion is formed by curing an aggregate of a small amount of ink.

9. A dynamic bearing device according to claim 7 wherein a second thrust bearing surface having a dynamic pressure generation portion is molded on the cover member.

10. A dynamic bearing device according to claim 7 wherein a second thrust bearing surface having a dynamic pressure generation portion is molded on the other end surface of the bearing member.

11. A dynamic bearing device according to claim 7 wherein the bearing member is made of a resin or a metal, and is formed by any one of injection molding, press forming, and machining.

12. A dynamic bearing device according to claim 7 wherein the cover member is made of a resin or a metal, and is formed by any one of injection molding, press forming, and machining.

13. A dynamic bearing device according to claim 7 wherein: the rotating member comprises a shaft member, and a rotor portion extending towards the outer diameter side of the shaft member and having a portion for receiving a rotor magnet; and a magnetic material is disposed at least at a portion of the rotor portion confronting the rotor magnet.

14. A motor comprising the dynamic bearing device according to claim 7, a rotor magnet, and a stator coil.
